(19) United States
(12) Patent Application Publication
(10) Pub. No.: US 2009/0011968 A1
(43) Pub. Date: Jan. 8, 2009

(54) Upper engine cleaning adaptors used to connect a pressurized unit containing an upper engine cleaner to the vehicles plenum

(76) Inventor: Paul Hughett, Jacksonville, FL (US)

Correspondence Address: KEITH D. NOWAK, CARTER LEDYARD & MILBURN LLP, 2 WALL STREET, NEW YORK, NY, 10005, US

(21) Appl. No.: 11/824,988

(22) Filed: Jul. 3, 2007

(51) Int. Cl. C11D 3/26

(52) U.S. Cl. 510/186; 510/185

(57) ABSTRACT

For decades the slow accretion of carbonaceous deposits on the upper cylinder areas of the internal combustion engines has acted to impair optimum performance and to significantly reduce gasoline or Diesel mileage per gallon. It has now been discovered that these formerly rather intractable engine deposits can be efficiently removed by dispersing and dissolving them through the use of optimized mixtures of polar protic and dipolar aprotic solvents that have the essential capability of acting in concert synergistically. For practical reasons these solvents must have a melting point higher than about 41° F. (5° C.). The finished product must also have a dielectric constant of about 20 and a pH value of at least 11.0 at 77° F. (25° C.). These parameters are considered vital to success. For example, in a test using a blend with a dielectric constant of 15, the removal of the carbonaceous deposits was either de minimus or very limited, even at pH values of 12.0 at 77° F. (25° C.) or higher. However, at a dielectric constant of 20 the degree of removal was quite satisfactory. Preferred compositions of this invention may be utilized in the form of self pressurized (aerosol) dispensers.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Over the past fifteen (15) years or so the chemistry of the injurious, baked-on carbonaceous deposits have changed somewhat, primarily due to improvements in petroleum refining and the need to comply with various federal and state regulations. Changes have also been made in the composition of gasoline and oil additives and in mechanical aspects of engines—now increasingly controlled and monitored by numerous computer chips. All are designed to provide more engine efficiency, thus increasing U.S. EPA mileage ratings, while decreasing noxious tailpipe emissions.

Despite these many sophistications the problem of carbonaceous deposits remains, and in fact, continues unabated. At least in part, these build-ups can be related to unsaturated hydrocarbons (olefinics), which constitute a significant percentage of fuels, and which cannot be removed by any economically feasible process. If anything, the more complex and sensitive nature of modern engines has made them more susceptible to the many problems cause by these insidious carbon-based deposits. The need for their periodic removal remains a pressing issue.

The problems arising from the accretion of these carbonaceous engine deposits can be described with more specificity. They cause a general loss of power in the internal combustion engine. Multiplicities of factors are involved. They may cause rogue combustions that are out-of-synchrony with the timing of the primary combustion sequence. Aside from the obvious “contra-combustion” event, this acts to steal fuel from the next primary combustion stage. One result is inefficient combustion, with unburned hydrocarbons then being emitted into the atmosphere through the exhaust pipe. These fuel hydrocarbons are recognized by the U.S. EPA and the various states as Volatile Organic Compounds (VOC's), which can then act indirectly to create more ozone in the air.

As is well documented, troposphere ozone is an extremely reactive and dangerous air contaminant, condemned by the National Academy of Science and other experts, and now regulated to a limit of 0.08 part-per-million in air as an official interpretation of the Clean Air Act Amendments of 1999. At this time most states are in non-attainment, and are straining their resources to be compliant, as evident from their State Implementation Plans (SIPs), submitted periodically to the U.S. EPA. Given this background, it will be seen that the minimization of unburned fuel (VOCs) is a very important element in tropospheric ozone reduction. It will be welcomed by both regulators and environmentalists as one of the many that will ultimately lead to cleaner air.

Carbonaceous build-ups on valve seats (valve tulips) cause loss of compression and an interference with optimum air-to-fuel ratios. Deposits in combustion chambers act to reduce the tension in compression rings. In turn, this reduces compressions, as well as engine power. Because of unbalanced piston compressions, engine vibrations will increase, causing excessive engine wear and reduced fuel mileage, plus even more emissions of unburned hydrocarbon fuel. Deposits on spark plugs also interfere with optimum fuel burn, due to the changing of their dynamic kilovoltage (KV) and millisecond pulse width. Carbonaceous deposits in the EGR valve are the cause of engine surging, rough engine syndrome and giving a check engine light. Similarly, these deposits on the oxygen sensor unit will cause a slow response to necessary air-fuel adjustments, making the ECM unit adjust the air-fuel mixture to ratios richer than the stoichiometric or optimum proportions. Without sufficient oxygen to burn the excess of fuel, the mileage-per-gallon will decrease and the unused fuel will be emitted into the atmosphere via the tail pipe. Finally, a build up of carbonaceous deposits on the catalytic converter screen will act to reduce the rate of heat transfer, ultimately causing the screen to disintegrate. When fragments are blown into the converter, permanent damage will result. The vehicle operator will generally be oblivious to the circumstance, often driving many thousands of miles with little or no remediation of the raw exhaust fumes before the next converter check-up.

Numerous studies have demonstrated that carbonaceous engine deposits can reduce fuel mileage by as much as 10%, and even as high as 15%, after 15,000 to 20,000 miles of driving, especially under city driving (stop-and-go) conditions. The physico-chemical action of my invention, when properly used as a preventative maintenance program—typically after 15,000 miles of city driving, or about 20,000 miles of rural driving—will act to increase fuel efficiency by an average of 15%. In today's world of high fuel prices, concerns about air quality and fears of global warming effects this improvement in fuel efficiency can be viewed as quite significant and welcome.

Laboratory test have been developed as early as 1985 to detect, develop and then maximized the synergistic chemistry of carbonaceous sludge removal. In particular, the Cold Spark Plug Immersion Test (CSPIT) was developed to access the ability of various solvent mixtures to disperse baked-on carbonaceous engine deposits. The preferred test is fully described in U.S. Pat. No. 4,992,187. Spark plug deposits were given a descriptive rating of A, B, C and D, in terms of their relative thickness and density. For example, soil type C represents a fairly serious deposit representative of about 10% of all spark plug deposits. Type D is the most serious, described as “a dense, dark, carbonized baked-on deposit” and this affects the majority of spark plugs. It is very similar to the deposits found on upper internal combustion engine surfaces.

In the interest of convenience the detail of the current test procedure are presented here as follows:
a. Approximately 100 used spark plugs must be obtained from a suitable engine tune-up shop or similar source.
b. These spark plugs are hand-sorted to separate out those that qualify as category D.
c. The category D spark plugs are briefly rinsed with a brake cleaner solution composed of one or more chlorinated solvents, such as trichloroethylene, after which they are dried for 24 hours at about 70 deg. F. (21 deg. C.).
d. The evaluation is made by partially immersing individual spark plugs in typical four fluid ounce (120 ml) jars containing 1.7 fluid ounces (50 ml) of test solution. After tightening the jar lid, the jar must be briefly tilt about 45 degrees, to allow the test solution to completely fill the hollow base that contains the spark plug electrode. The jar is then stored upright for exactly five minutes at about 70 deg. F. (21 deg. C.).
e. The jar is then opened and the spark plug removed—shaking it slightly to assure that the test liquid inside the spark plug fully drains back into the jar.
f. The 1.7 fluid ounces (50 ml) of test solution is then diluted with de-ionized water to 250 ml.
g. A suitably small aliquot of this mixture is then transferred into a colorimetric tube and placed in an Orbeco-Hellige tester, so that the color can be compared to a standard No. 620-C-43 Low Varnish Hellige Color Disc. The disc is selected to provide a range of 1 through 9 color scale, referencing ASTM D-1544. A second disc may be used, identified as standard No. 620-C-44 for High Varnish Colors. This provides an extended range: from 9 through 18.
h. Experience has shown that a reading of ten (10) signifies 100% removal of the baked-on carbonaceous deposit. A reading of nine (9) is equivalent to a 90% removal, and so forth.
   This experimental technique has been shown to be highly reliable as a valid screening process for evaluation and ability of various test solutions to disperse and dissolve carbonaceous deposits from upper cylinder engine surfaces.

### BRIEF SUMMARY OF THE INVENTION

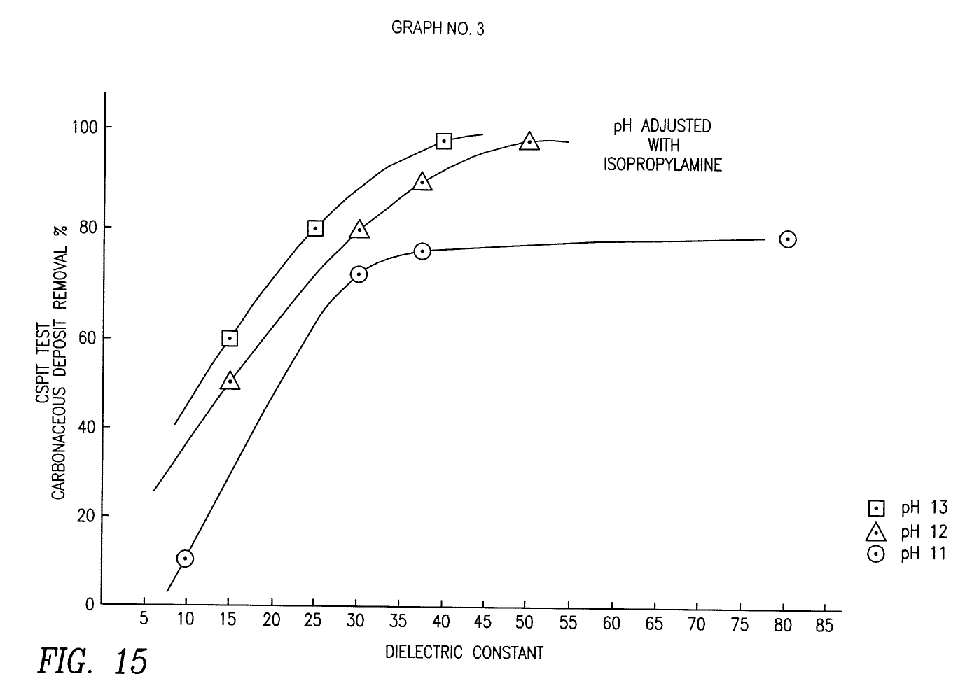

Our invention can be employed to provide a series of synergistic liquid mixtures, each capable of dispersing and dissolving modern baked-on carbonaceous deposits from the surface of the upper cylinder area of internal combustion engines, including the spark plugs and all the other component surfaces in this enclosure. Maintaining surface cleanliness is a major element in sustaining maximum operating efficiency of these engines. We have found that polar protic and dipolar aprotic solvents, either independently or in blends having a dielectric constant above 25 or more, can be synergized by raising the pH value to 11 or above (at 25 deg. C.). (See FIG. 15, Graph No. 3).

As the dielectric constant increases beyond 30, cleaning efficacy also increases. Methyl Formamide, with a uniquely high dielectric constant in excess of 200, is unusually effective. We have, in fact, found two single compounds able to clean modern upper cylinder carbonaceous deposits without the usual need to be synergized. These are Hydrazine (and certain close derivatives), with a dielectric constant of about 53 and a pH valve of over 13 (at 25 deg. C.), as well as concentrated aqueous Ammonium Hydroxide Solutions (typically with 28.6% ammonia content), and having a dielectric constant of about 61 and a pH valve of over 13 (25 deg. C.).

Our invention provides three distinct techniques for cleaning the component of the upper cylinder area of internal combustion engines. These are:
1. A preventative technique, wherein the synergistic product is delivered as a finely particulated spray into the plenum of the upper engine while the engine is at idling speed. The product is ideally delivered from a self-pressurized (aerosol) dispenser. Once attached to the plenum by means of a hose and adapter, the aerosol actuator is fully depressed and locked down. The system is then fully independent of manual control and can be left alone until the injection operation is complete. The length of chemical contact time is approximately five (4) to six (7) minutes, depending on the I.D. of the capillary dispensing tube, which produces optimum delivery rate—and is thus the same as in the laboratory simulation test.
2. A “hands-on” engine maintenance technique, where the synergistic composition is delivered into the engine plenum in the form of a heavy, oscillating type residual spray, while the engine is running at about 1500 rpm. This mode requires constant control by an operator.
3. This technique involves a maintenance process requiring that a trained mechanic remove the spark plugs from a fully warmed-up engine, and then, using a special adapter, simply attach to the self-pressurized (aerosol) and then enter the tip of the adapter into the threaded spark plug hole. The synergistic formulation is then sprayed into each upper cylinder area for five (5) seconds, after which the spark plugs are replaced with one thread turn or very loose and then the engine is permitted to hot soak for approximately one hour. All of the spark plugs are then removed and a towel, wet with water, is placed over the spark plug holes. Then spend the engine, thus through-in out, the liquid carbonaceous deposits which are absorbed into the wet towels safely.

In the marketing of products that take advantage of this invention, aerosols with the desired synergistic composition and pre-determined delivery rate would be made available, together with the appropriate connector of plastic tubing and adapters. Each aerosol dispenser could be sized to provide maintenance for a multiplicity of internal combustion engines.

### BRIEF DESCRIPTION OF THE SEVERAL VIEWS OF THE DRAWINGS

In the drawings:

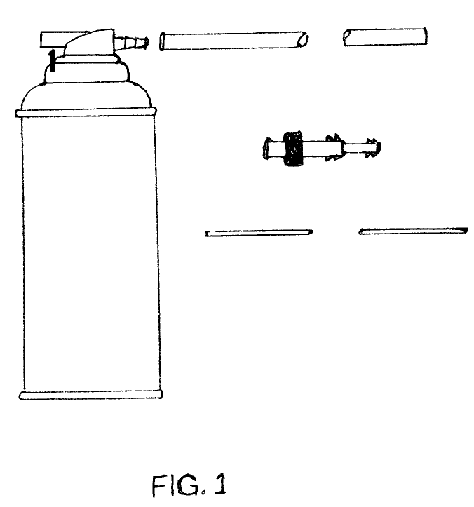

1. FIGS. 1-3: Illustrate an aerosol dispenser and adaptors for use with the invention,

2. FIGS. 4-8: Illustrate various Tables setting forth the various chemical compositions relating to the invention,

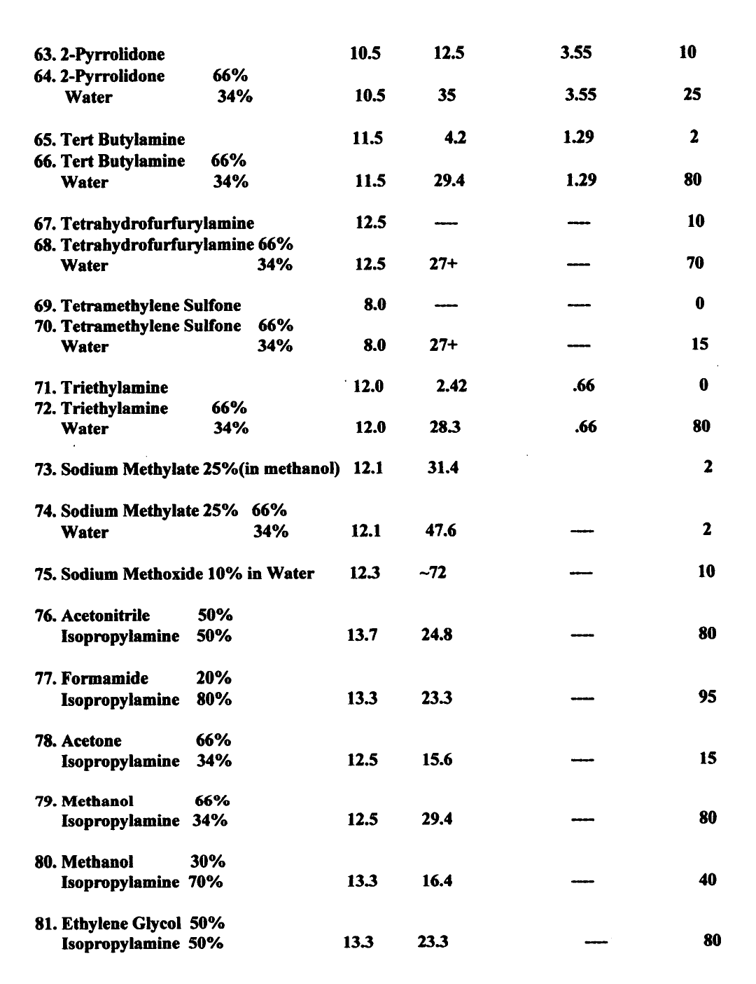

3. FIGS. 9-12: Illustrate various means for delivering the chemical composition of the invention to approximate areas of an engine, and

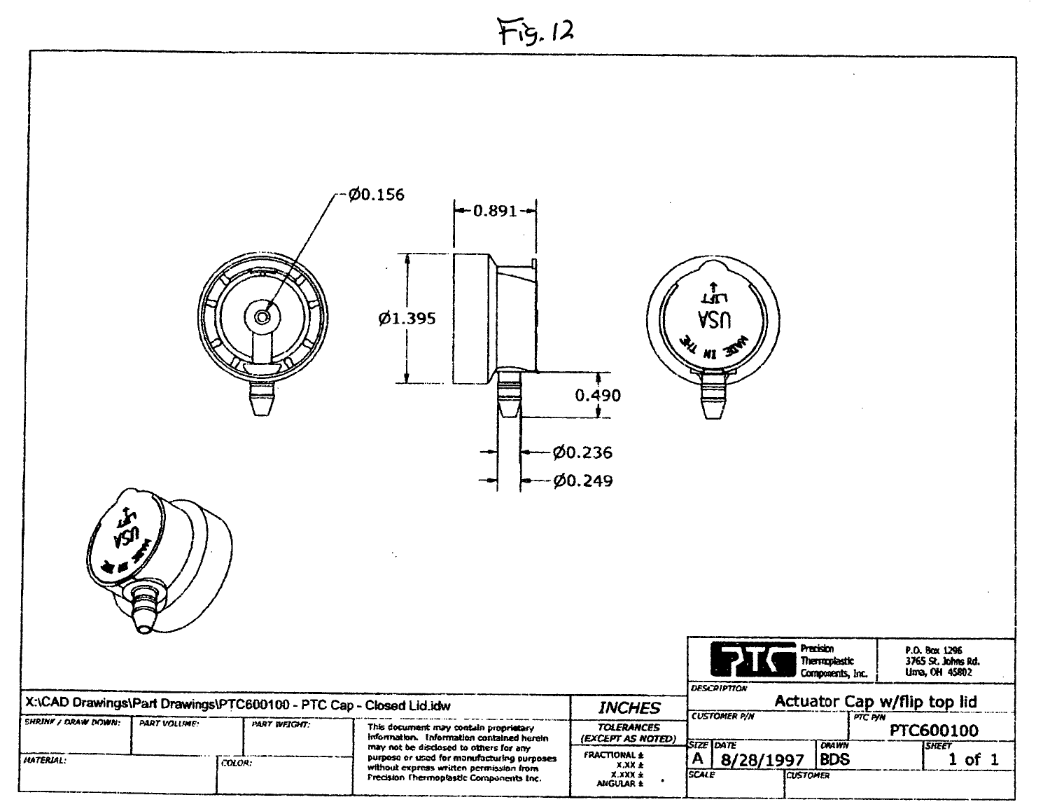

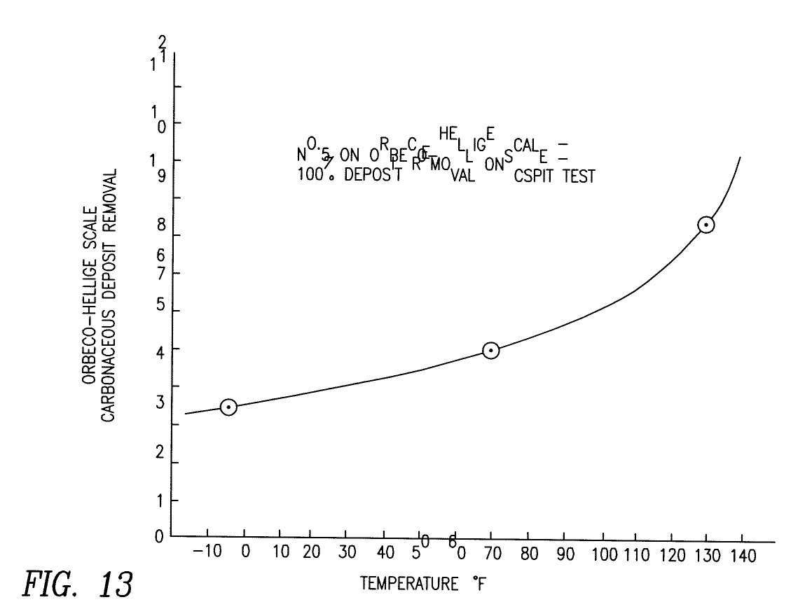

4. FIGS. 13-15: Illustrate graphs demonstrating effective use of the invention.

### DETAILED DESCRIPTION OF THE INVENTION

Our invention provides specific compositions of matter ideal for dispersing and dissolving dense layers of heavy, baked-on carbonaceous deposits that form on surfaces within the upper internal combustion engine chambers; wherein a polar protic or dipolar aprotic solvent is synergized with a primary, secondary or tertiary amine, up to a pH valve of a least 11 (at 25 deg. C.). As notation alkali metal hydroxides cannot be used as synergists because of their ability to chemically attack aluminum engine components, etching the metal and producing solid aluminate salts that are potentially more damaging to the engine than the carbonaceous deposits.

We have found that high dielectric constant formulations with pH valves ten (10) or less display little or no ability to disperse and dissolve carbonaceous deposits. (See FIG. 4, Table One for details.) Additionally, formulas with a satisfactory pH value 11 to 13 plus, but with a dielectric constant below about 15, also shows very limited ability to disperse and dissolve these deposits. (See FIG. 5, Table Two for details.) However, compositions with suitably high pH values (above 11) and dielectric constants (above 25) display very satisfactory removals of carbonaceous deposits, typically 80 to 100%. (See FIG. 6, Table Three for details.)

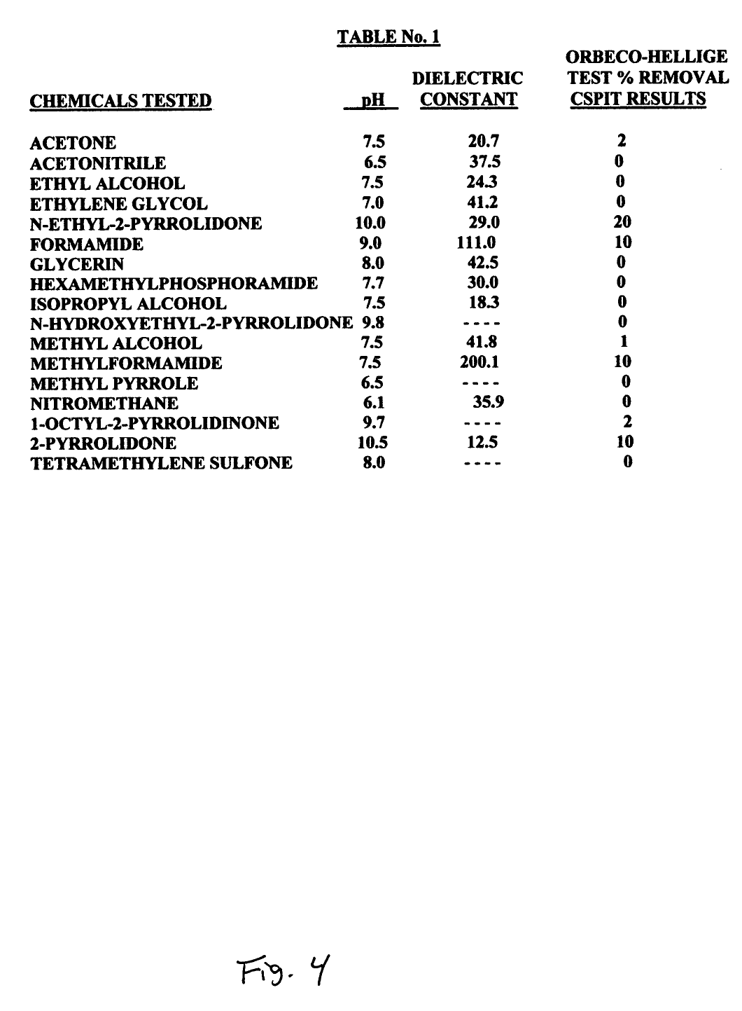

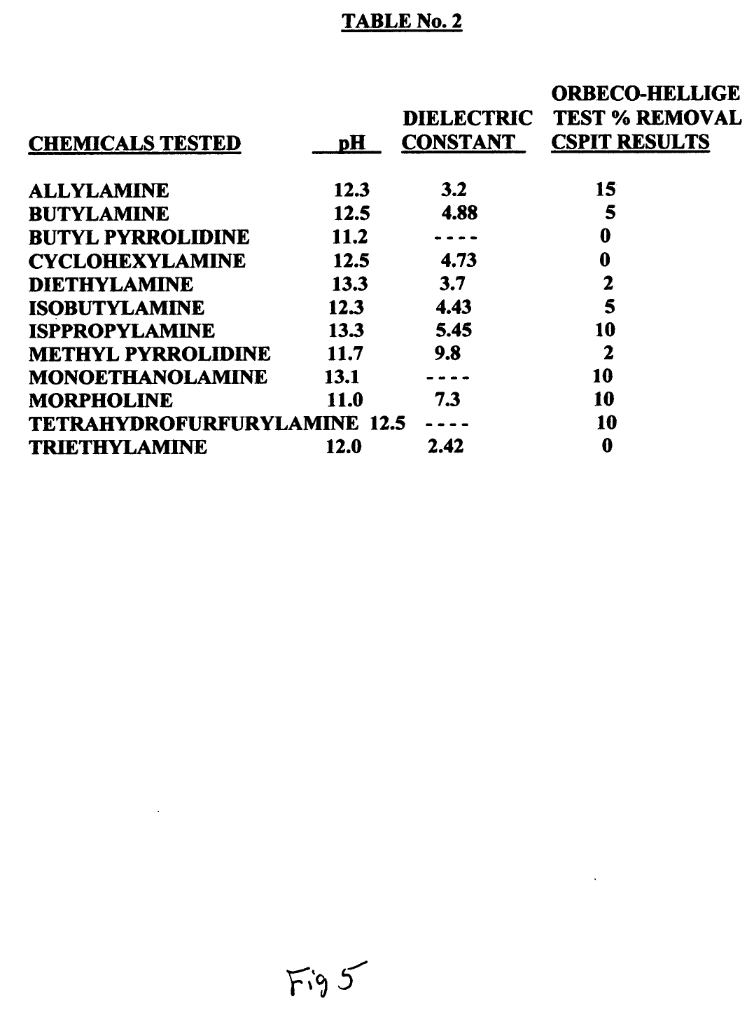

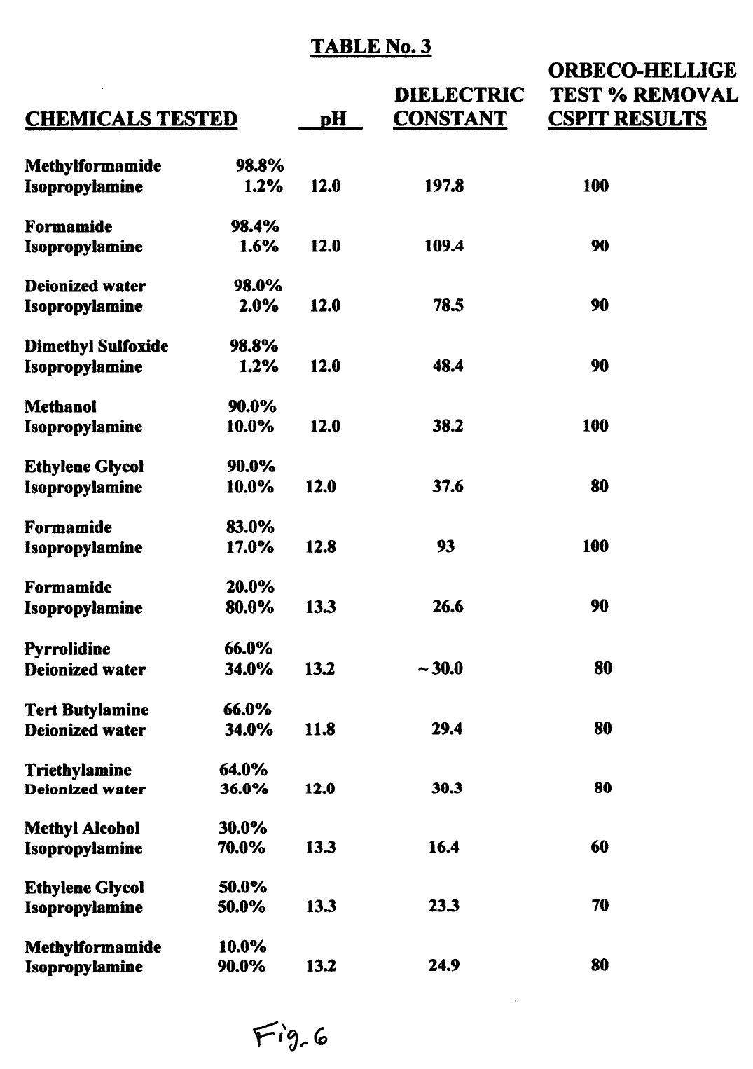

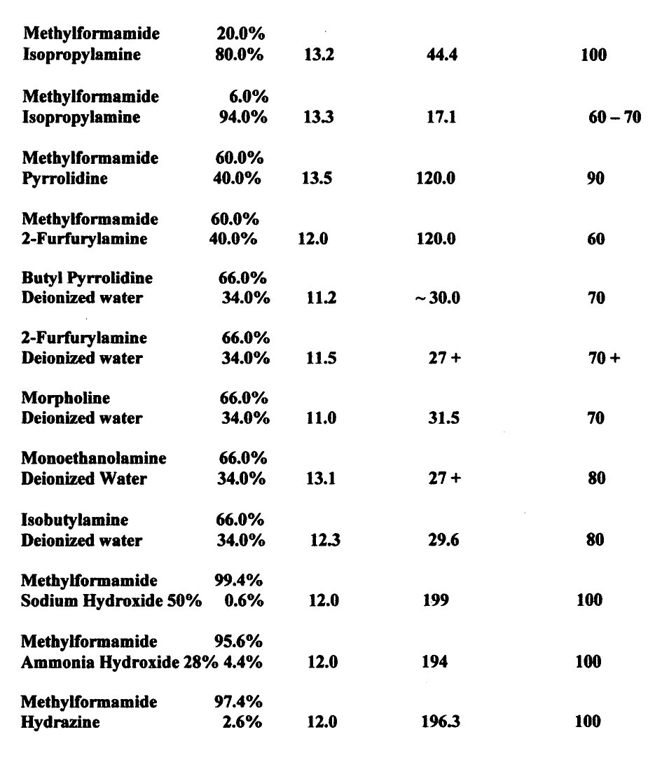

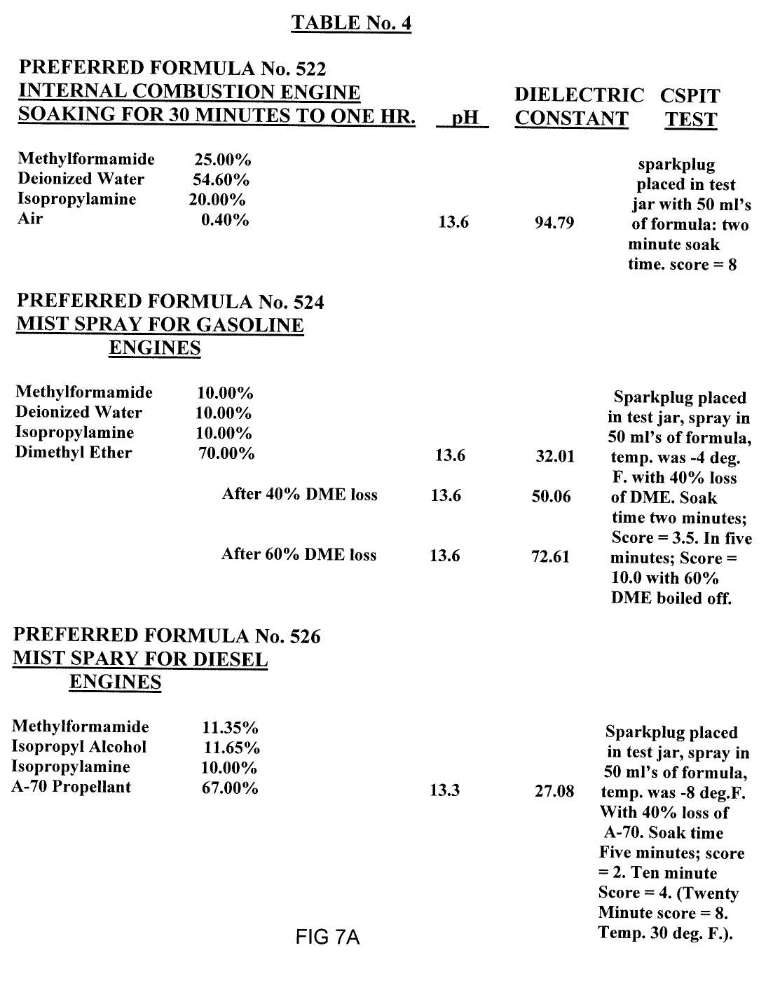

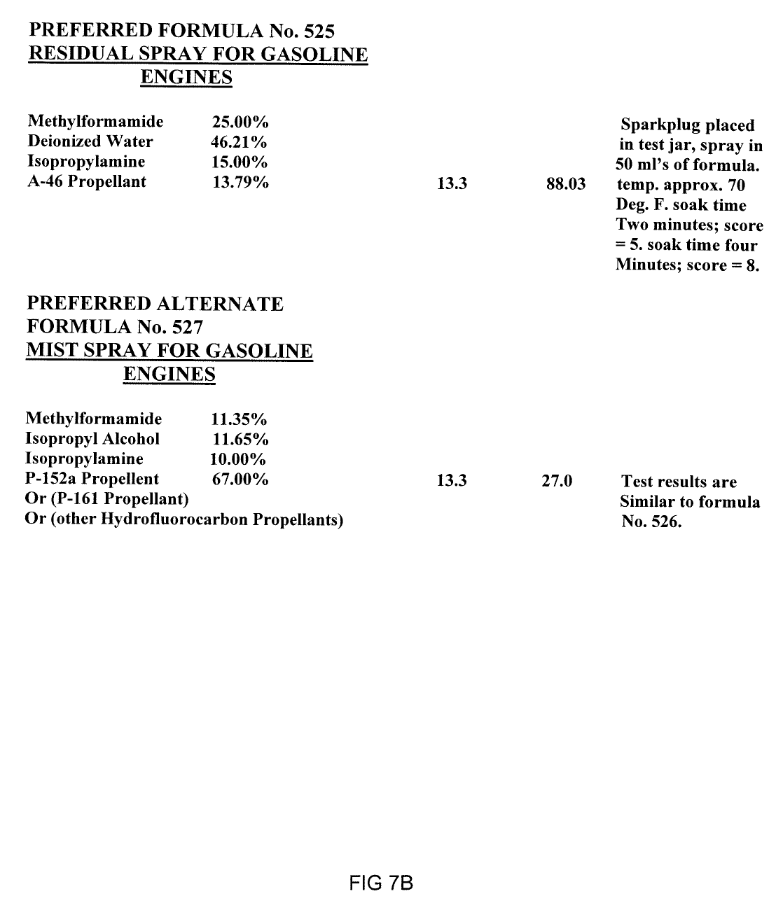

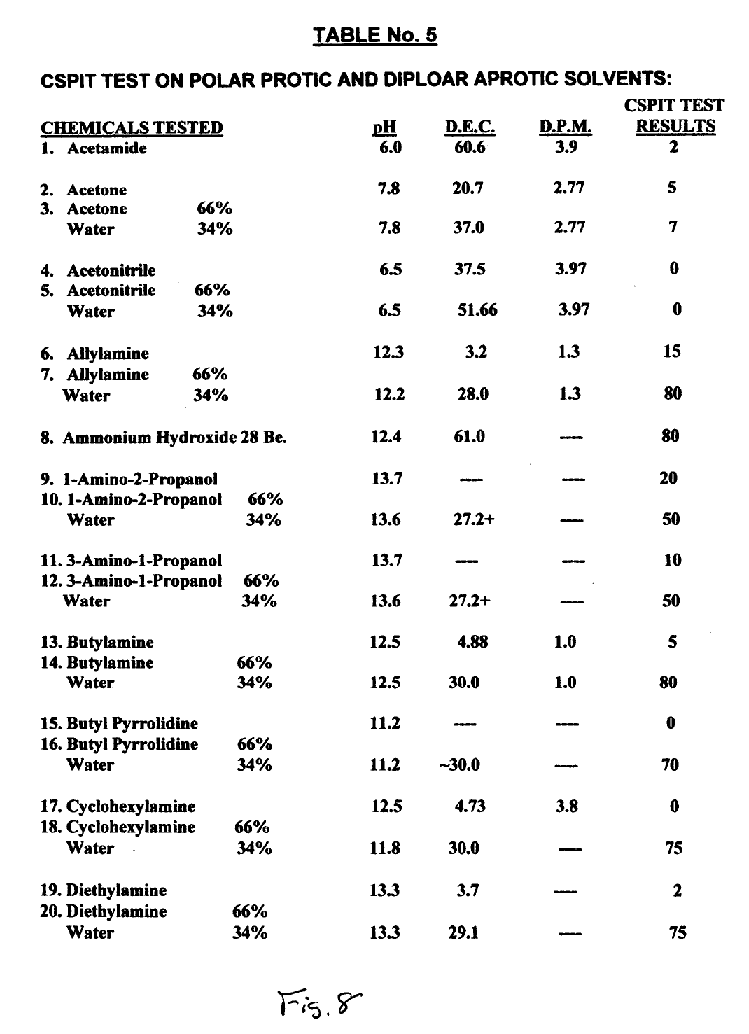

Test results from actual cleaning of upper engine areas show that, ideally, the synergistic cleaning compositions should have a pH of 13 (at 25 deg. C.) or higher, and a dielectric constant of 35 or higher. This high level of cleaning efficiency is required because of limits imposed on engine cleaning time by OE shops, which is usually in the range of 5 to 10 minutes. (See FIG. 7, Table Four.) The optimized upper engine aerosol formula for gasoline engines has a pH value of about 13.6 (25 deg. C.) and a dielectric constant of 32.01. When this optimized composition is blended in the order listed, (with moderate agitation) the batch temperature increases by approximately 16% after adding De-Ionized Water to N-Methylformamide and then increases another 16% when the primary alkylamine is added. Accordingly the blend tank should be tightly closed and maintained with slow agitation until the batch temperature returns to room temperature. The blending room should be well ventilated. The aerosol is made by a two stage fill. First filling the concentrate into the aerosol unit and then pressure filling with the propellant and mechanically crimping the valve onto the aerosol unit. When this composition is sprayed into a test jar, using the appropriate adapter, about 40% of the product is gassed-off, due to propellant evaporation. The remaining fluid, approximately 50 ml of liquid product will typically have a temperature of about −4 deg. F. (−20 deg. C.). (50% or more of the propellant evaporates when sprayed into the plenum of a warmed-up engine, which raises the dielectric constant of the fluid to 50 plus).

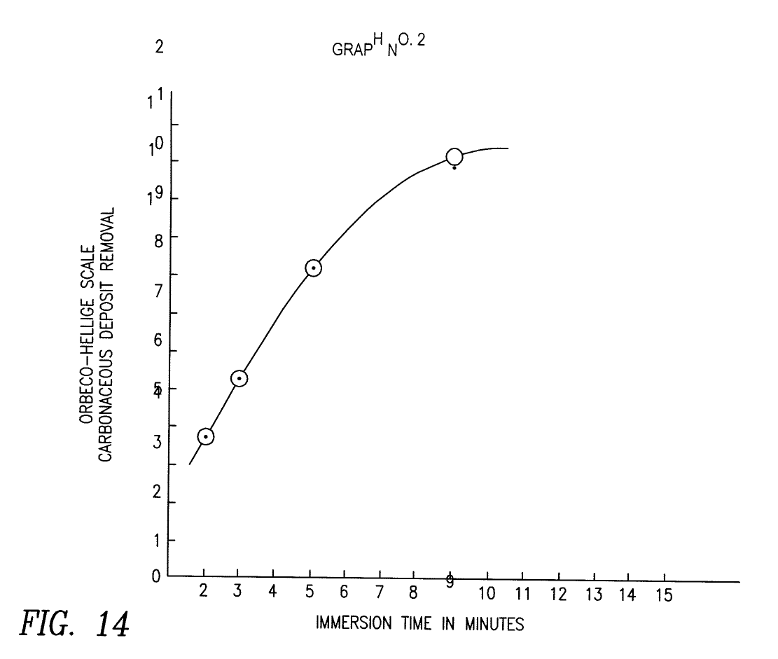

To conduct the spark plug cleaning test, the plug must be lowered very slowly into the very cold liquid. This will cause some boiling, but will avoid an excessive boil-out and loss of some liquid. Use a stopwatch or other timer and wait for two (2) minutes; then lift out the plug. The test solution is then slowly poured into the standard 250 ml cylinder and brought to 250 ml with De-ionized Water, taking care not to have an excessive final boil-off of propellant. Stir until uniform. Transfer some of this solution into the Orbeco-Hellige glass tube and insert into the colorimetric test unit. Under these very cold conditions the scale reading will typically show 3.4, indicating that about 35% of the baked-on carbonaceous deposit has been dispersed and dissolved. If the same experiment is performed, but now at 70 deg. F. (21 deg. C.) the scale reading will be about 5.0. At 100 deg. F. (38 deg. C.) the reading is about 6.2, and at 130 deg. F. (54 deg. C.) it is 8.5. (These data are displayed on FIG. 13, Graph Number One.) The solubility activity continues to increase at still higher contact temperatures. (See FIG. 14, Graph Number Two). Diluting the test sample in De-ionized Water and then transferring an aliquot sample of the dilution for reading should be conducted as quickly as possible for accurate readings. When the diluted test solution sets for five (5) to ten (10) minutes a gelatinous precipitation occurs which interferes with an accurate reading.

On a fully warmed engine the lower area of the plenum temperature will average about 150 deg. F. (62 deg. C.), and this increases to about 220 deg. F. (105 deg. C.) on the surfaces of the intake valves. Engine test have shown that the optimum time for the synergistic composition to contact the carbonaceous deposits in these areas to be between four (4) to six (6) minutes.

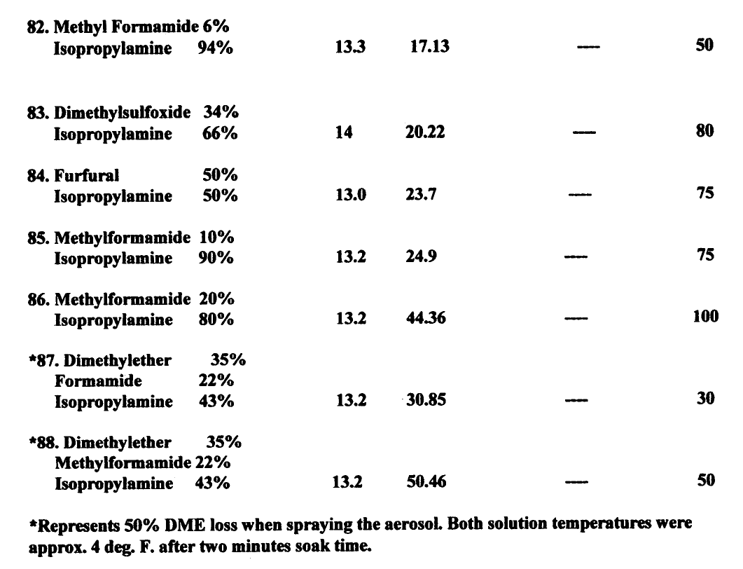

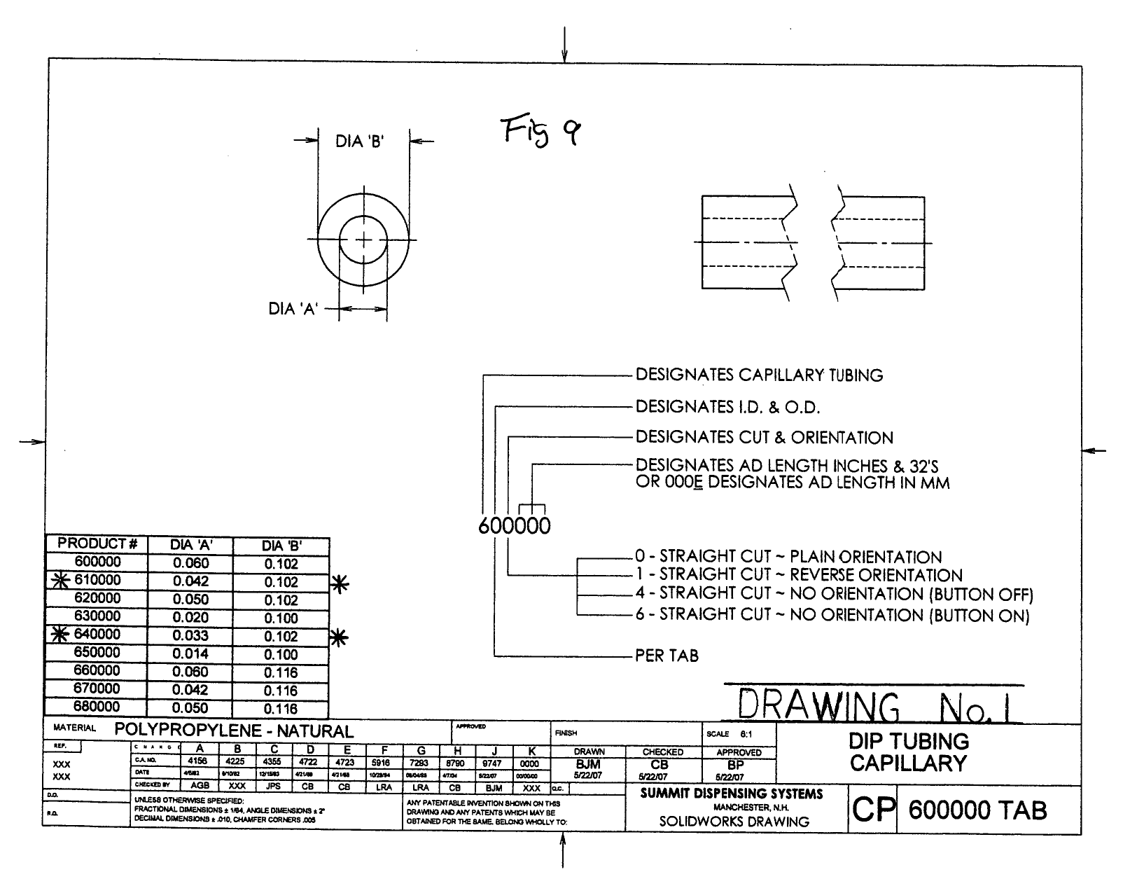

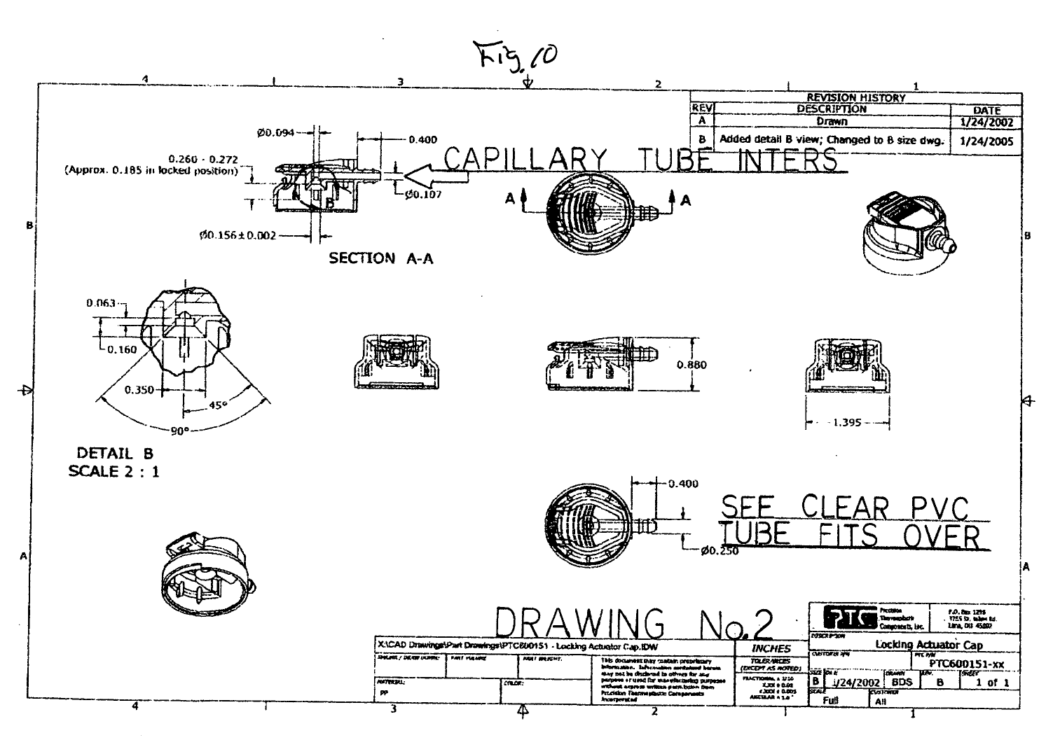

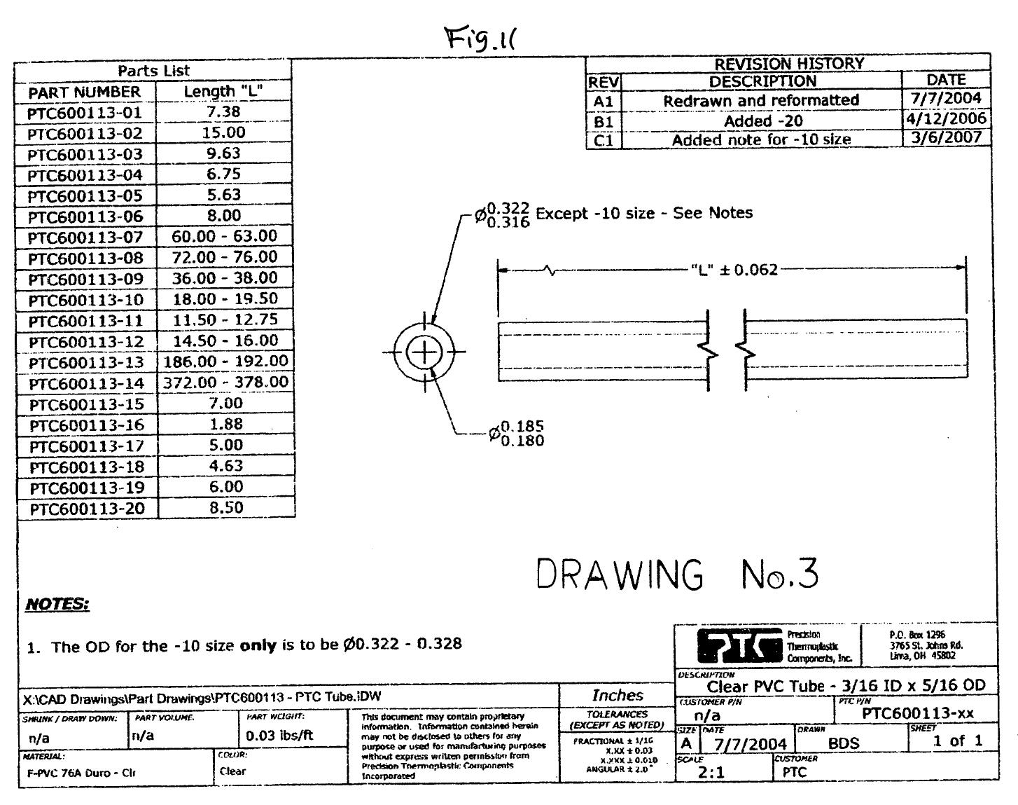

The optimized formula for preventative maintenance, as illustrated in FIG. 7, Table Four (Formula 524), is packaged as a 7.5 ounce (212 grams) filled in an aerosol container, which is then attached to the upper engine plenum by the use of a special adapter (FIG. 1). It is important to assure that the product is delivered into the plenum in form of a mist of finely divided particles. To do this we have selected two capillary type extension tubes; one with a 0.033″ (0.84 mm) and one with a 0.042″ (1.07 mm) inside diameter. [See FIG. 9, Product Part No. 610000 (0.042 I.D.) and Product Part No. 640000 (0.033 I.D.)]. These capillary tubes are inserted into a Locking Actuator Cap. The O.D. of the capillary tube is 0.102″ (02.59 mm) and the I.D. of the tube housing which protrudes from the Locking Actuator Cap is 0.107″ (2.718 mm) and narrows to 0.100″ (2.54 mm) at the center of the Actuator. [See FIG. 10]. The capillary tubes are pressed firmly toward the center of the Actuator and extend out ward 30″ to 40″, (this long adapter lets the user place the aerosol unit away from the hot vehicle engine during the cleaning process). A clear PVC tube is placed over the capillary tube for protection and pressed fitted over the protruding tube-housing on the Actuator and then a multi-adapter is inserted into the other end of the clear PVC tube, so this can be attach to the air intake vehicle plenum, (See FIG. 11, clear PVC tube.) and (See FIG. 12, multi-adapter for the vehicle plenum). The capillary tube will protrude approximately one inch (1″) out of the multi-adapter, so that the synergistic spray mist goes directly into the plenum. Using the 0.033″ (0.84 mm) capillary tube adapter gives a product delivery rate of about 0.50 grams per second and will last approximately seven minutes. The 0.042 (1.07 mm) capillary tube adapter delivers about 0.90 gram of product per second and will empty the aerosol unit in approximately four (4) minutes. The lower delivery rate works best for small gasoline and diesel engines.

A preferred use of this product is to attach the over-cap actuator onto the aerosol valve stem and mounting cup, and then position the other end of the eductor tube, protruding through the variable diameter plenum adapter, into the upper engine plenum. Then slowly depress the actuator pad until a mechanical feature locks the valve in an “open” position. The aerosol unit will then spray until it is empty. The discharge rate is normally four (4) to seven (7) minutes depending on the size of the capillary I.D. selected. Since there is no operator present, in the event that the engine should stall, the aerosol will continue to spray until empty. This controlled spray mist will not cause any harm to the stalled engine, because this capillary adapter prevents the possibility of discharging the synergistic mixture as a heavy wet spray or liquid stream that would tend to run down the plenum wall to the closest intake runner. It would then accumulate behind a single intake valve, or if that valve was open, it would then leak down upon the top of the piston. If these things happen, when the operator attempts to start the engine, there will be the risk of hydraulically locking it, cracking the top of the piston or bending a piston rod, thus severely damaging or even destroying the engine.

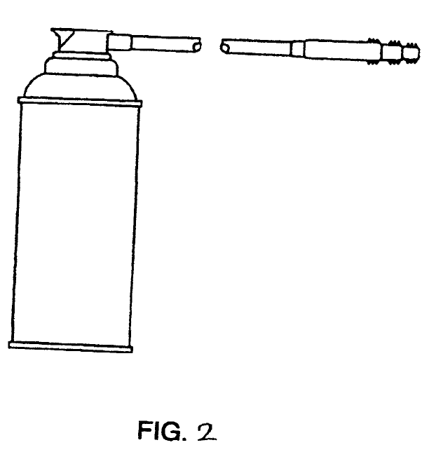

The optimized Diesel mist formula (FIG. 4, Table Four), Formula 526, also requires the use of this same adapter, which will deliver a finely particled mist into the center of the intake air flow, after the air filter has been removed, and when the diesel engine is at idle speed. Alternatively, a different formula (FIG. 4, Table Four), Formula 525, can utilize this same adapter without the capillary inner tube and without a lock-down aerosol valve actuator. (This is illustrated in FIG. 2). The adapter for this assembly is designed to deliver a heavy, wet, residual spray into the plenum of a gasoline engine and adjust the engine speed to about 1500 rpm. The mechanic will then shake the aerosol dispenser, using a spray and release technique until the aerosol is empty. This spray technique requires the mechanic to fully actuate the aerosol dispenser for about 5 to 10 seconds, this will produce a flooding action in the upper engine which will cause the speed to decrease to about 500 rpm. The mechanic will then shut off the spray and this will allow the engine to recover its original speed of about 1500 rpm. The procedure is repeated, until the aerosol is less than about 5% full. At this point, the aerosol should be actuated until the engine stalls, after which the dispenser can be sprayed for a few more seconds until the can is empty.

The mechanic will then let the engine “soak” for ten (10) to fifteen (15) minutes. Then he should crank the engine very slowly until it has made one complete revolution, after which regular cranking can be initiated until the engine starts. The engine is brought to about 3000 rpm, then snapped to about 5000 rpm briefly, to blow out any loose carbonaceous fragments. Finally, the vehicle should be driven for 3 to 5 miles, to fully exhaust the combustion chambers and catalytic converter.

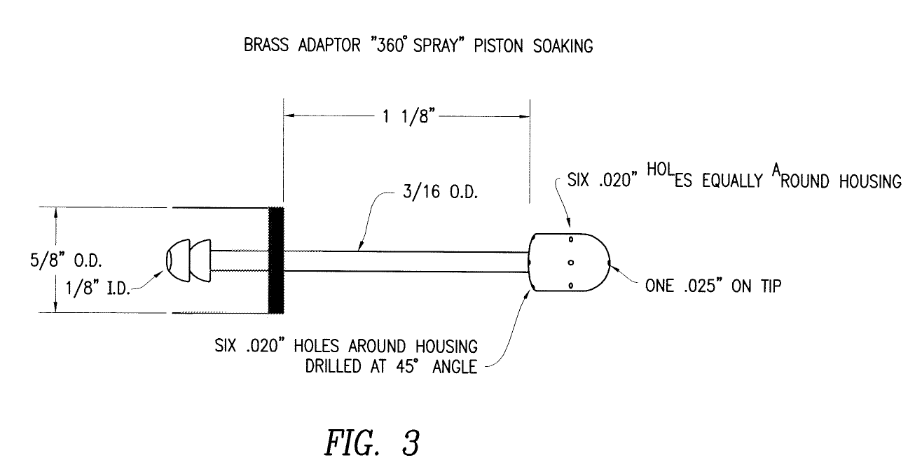

Over 300 tests have been conducted, to fully refine and demonstrate the superior upper engine cleaning activity, resulting from the use of this high dielectric constant formulation, when synergized by the inclusion of high pH valve ingredients, and when applied to older vehicles and some relative new vehicles, Formula 525 can be effectively used to “soak” cylinders, to clean entire combustion chambers, cylinder domes, piston heads and to release compression rings that have been frozen into place by hard carbonaceous depositions. This cleaning technique requires the use of a unique adapter 360 degree tip (illustrated in FIG. 3), attached to a standard plenum adapter, by replacing the multi-adapter tip with the 360 degree brass spray tip.

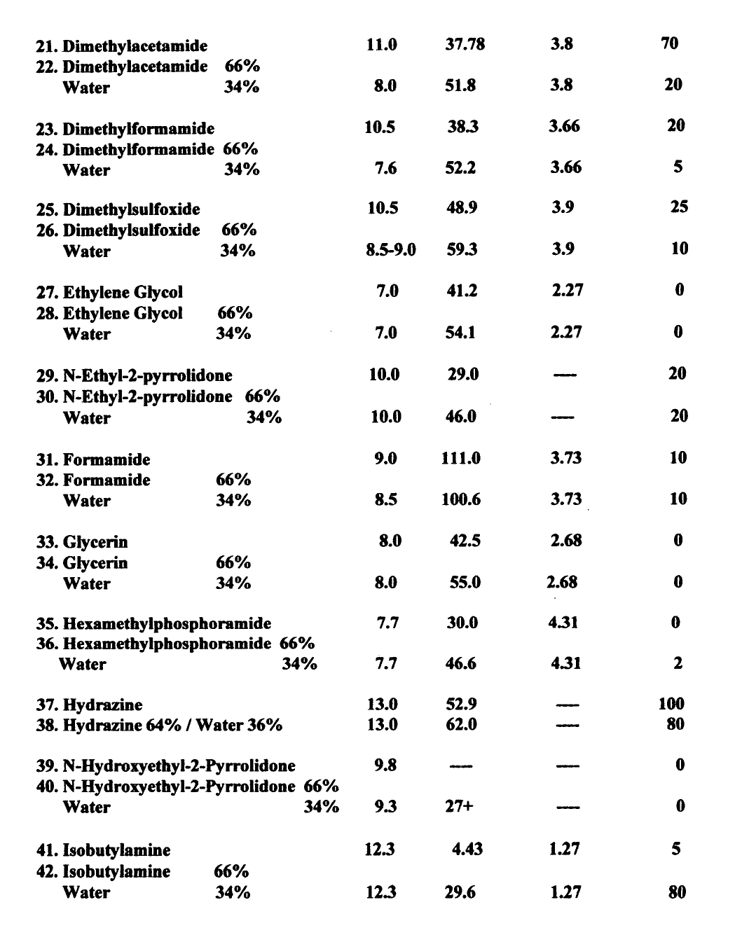

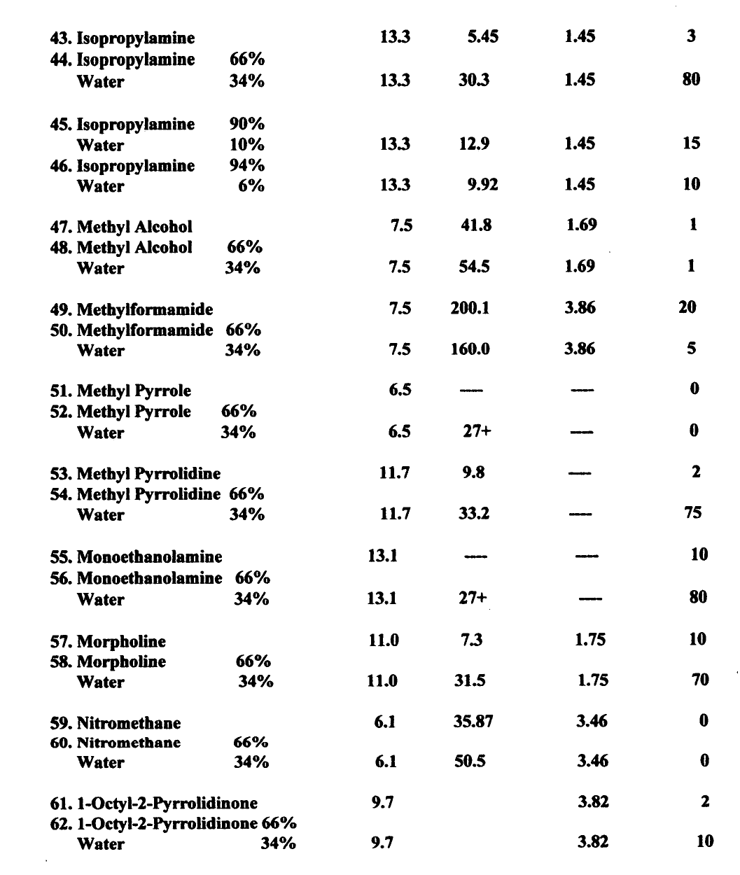

See FIG. 8, Table No. 5 for a more complete summary of data listed in Tables No's. 1, 2 and 3. There does not appear to be a direct correlation between the chemicals dipole moment and synergism.

1. An upper internal combustion engine cleaner composition comprising:
(a) one or more polar protic or dipolar aprotic solvents each having a melting point above 320° F. (0° C.),
(b) wherein said solvents are selected from the following group that have dielectric constants ranging from 200 to about 15 as indicated after the solvent name:

| | |
|---|---|
| N-Methylformamide | 200.1 |
| Formamide | 111.0 |
| Water | 80.0 |
| Ammonium Hydroxide 26.8% | 61.0 |
| Nitrosodimethylamine | 54.0 |
| Hydrazine | 52.9 |
| Dimethyl Sulfoxide | 48.9 |
| Glycerin | 42.5 |
| Methanol | 41.9 |
| Ethylene Glycol | 41.2 |
| Dimethyl Formamide | 38.3 |
| Dimethyl Acetamide | 37.8 |
| Acetonitrile | 37.5 |
| Nitromethane | 35.9 |
| Hexamethyl Phosphoramide | 30.0 |
| N-Ethyl-2-Pyrrolidone | 29.0 |
| Ethanol | 24.3 |
| Allyl Alcohol | 22.8 |
| Acetone | 20.7 |
| Isopropanol | 18.3 |

and
(c) wherein said composition contains a synergistic amount to bring the pH value to 11 (at 25° C.) or higher, of a compound which is an organic alkaline nitrogen-containing compound.

2. The upper engine cleaning composition of claim 1 wherein the alkaline nitrogen-containing compound is select from the group of primary, secondary or tertiary alkylamines, hydrazine, ammonium hydroxide solutions, quaternary ammonium hydroxides, and their derivatives.

3. The upper engine cleaning composition of claim 1 wherein the alkaline nitrogen-containing compound is a primary, secondary or tertiary amine.

4. The upper engine cleaning composition of claim 1 wherein the alkaline nitrogen-containing compound is a primary amine.

5. The upper engine cleaning composition of claim 1 wherein the alkaline nitrogen-containing compound is a secondary amine.

6. The upper engine cleaning composition of claim 1 wherein the alkaline nitrogen-containing compound is a tertiary amine.

7. The upper engine cleaning composition of claim 1 wherein the solvent having the dielectric is an alkylamide.

8. The upper engine cleaning composition of claim 7 wherein the alkylamide is methylformamide.

9. The upper engine cleaning composition of claim 1 wherein the solvent having the dielectric constant is hydrazine.

10. The upper engine cleaning composition of claim 1 wherein the solvent having the dielectric constant is an ammonium hydroxide solution.

11. The upper engine cleaning composition of claim 1 wherein the solvent having the dielectric constant is a quaternary ammonium hydroxide.

12. The upper engine cleaning composition of claim 1 wherein the synergistic solvent composition is blended with dimethyl ether (DME) and wherein the final blend has a dielectric constant above 15, with a pH value above 11, and is packaged in a self-pressurized aerosol dispenser.

13. The upper engine cleaning composition of claim 12 which is delivered to a motor vehicle plenum via a protected capillary tube and an adapter, providing a finely particulated, misty spray, suitable for cleaning baked-on carbonaceous deposits from an upper engine surface while said engine is idling, and without the presence of an operator.

14. The upper engine cleaning composition according to claim 1, wherein the composition is blended with hydrocarbon propellants selected from propane, isobutene, n-butane and mixtures thereof, and where the final blend has a dielectric constant above 15 and a pH value at 25° C. Above 11, and which is packaged in a self-pressurized aerosol dispenser.

15. The upper engine cleaning composition of claim 14 which is delivered to a motor vehicle plenum via a protected capillary tube and an adapter, providing a finely particulated, misty spray, suitable for cleaning baked-on carbonaceous deposits from an upper engine surface while said engine is idling, and without the presence of an operator.

16. The upper engine cleaning composition according to claim 1, wherein the composition is blended with 1,1-difluoroethane (HFC-152a), fluoroethane (HFC-161), or other hydrofluorocarbon propellants and where the final blend has a dielectric constant above 15 and a pH value at 25° C, greater than 11, and which is packaged in a self-pressurized aerosol dispenser.

17. The upper engine cleaning composition of claim 16 which is delivered to a motor vehicle plenum via a protected capillary tube and an adapter, with valve orifice and inside capillary diameter designed to provide a finely particulated, misty spray, suitable for cleaning baked-on carbonaceous deposits from an upper engine surface while said engine is idling, and without the presence of an operator.

18. The upper engine cleaning composition of claim 1, wherein the synergistically activated solvent has a dielectric constant of at least 35 and a pH value of at least 12, at 25° C., and is packaged in a self-pressurized aerosol dispenser.

19. (canceled)

20. (canceled)

21. (canceled)
